(19) United States
(12) Patent Application Publication
(10) Pub. No.: US 2022/0018187 A1
(43) Pub. Date: Jan. 20, 2022

(54) DOOR ASSEMBLY SIDE COLUMN CONFIGURATION

(71) Applicant: Rytec Corporation, Jackson, WI (US)

(72) Inventors: Daniel J. Gregoriou, Kewaskum, WI (US); Brian Norbert Drifka, Richfield, WI (US); Gabriel John Biertzer, West Bend, WI (US)

(21) Appl. No.: 17/375,864

(22) Filed: Jul. 14, 2021

Related U.S. Application Data
(60) Provisional application No. 63/051,655, filed on Jul. 14, 2020.

(51) Int. Cl. E06B 9/58; E06B 9/13; E06B 9/17

(52) U.S. Cl. CPC E06B 9/581; E06B 9/17046; E06B 9/13

(57) ABSTRACT

A door assembly having a first side column and a second side column, wherein the first side column is positioned proximate a first side of the doorway and the second side column is positioned proximate a second side of the doorway, the first side column and the second side column each comprising a guide track and each guide track comprising a first portion and a second portion. The first portion of each guide track defines a first guide channel having a first depth extending from a rear portion of each guide track to a first engagement portion of each guide track, and the second portion of each guide track defines a second guide channel having a second depth extending from the rear portion of the guide track to a second engagement portion of each guide track, with the second depth being less than the first depth.

### RELATED APPLICATIONS

The present application claims the filing benefit of and priority to U.S. Provisional Patent Application No. 63/051,655 filed Jul. 14, 2020, the contents of which are fully incorporated herein by reference.

### FIELD OF THE INVENTION

The present invention is directed to a door assembly and related components. More specifically, the present invention is directed to an improved guide track system with increased disengage ability and wind load resistance at various points within the guide tracks in overhead roll-up door assemblies.

### BACKGROUND OF THE INVENTION

Overhead roll-up door assemblies like those found in U.S. Pat. No. 8,607,842 typically include a flexible door panel which is guided within side columns and/or guide tracks positioned on opposite sides of a doorway as the flexible door panel is opened and closed. In order to move the door panel within the guide tracks and open and close the door, a drum and motor combination is typically provided, with the door panel being fixed at one end to the drum. The motor is typically mechanically coupled to the drum so that activation of the motor in a first direction causes the drum to rotate in a first direction, and activation of the motor in a second, reverse, direction causes the drum to rotate in a second direction. As the drum rotates in one direction, the first direction for example, the door panel will begin winding up on the drum, opening the doorway which was previously blocked by the door panel. As the drum rotates in the opposite direction, the second direction for example, the door panel will unwind from the drum, blocking the previously open doorway. In some door assemblies, two drums may be utilized, with a first drum coupled to the motor to drive the door panel opened and closed, and a second drum is provided to which a top portion or edge of the door panel is fixed to in order to facilitate winding and unwinding of the drum.

In order to prevent the door panel from disengaging from the side columns as the door is opened/wound and closed/unwound, thickened bodies or other elements like nubs or teeth may be used along the vertical edges of the door panel. These thickened bodies or other elements may prevent the door panel from disengaging from a side column and/or guide track when a pressure differential exists on opposing sides of the door panel, or when wind load is applied to one side of the door panel.

The use of thickened bodies or other elements along the vertical edges of the door panel, however, makes disengagement and subsequent reengagement of the door panel in response to an impact hit more difficult. In order to accommodate disengagement, the side columns and/or guide tracks may be made with flexible materials and/or be provided with a larger gap to help permit the thickened bodies or other elements and door panel escape from the side columns or guide tracks if the door panel is impacted. Using too flexible a material, or making the gap too wide, however, negatively impacts the wind load or pressure differential resistance of the door panel.

In addition to thickened bodies or other elements along the outer edges of the door panel, a weighted bottom bar may be attached to a lower end of the door panel so that the door panel remains taut in the guide tracks and doorway opening, and to insure the bottom of the door panel is weighed down. Weighted bottom bars help prevent wind pressure on one side of the door panel, or pressure differentials on opposing sides of the door panel, from causing the door panel to disengage the guide tracks as it opens, closes, or stops and remains static in a partially or fully closed position. In order to simplify the door assembly and control system while maintaining safety, some doors may forego the use of a bottom bar, but such doors may have slack or the like along the door panel, and particularly along the bottom edge of the door panel, when the door panel is partially or fully closed.

The present invention aims to provide such a system and method.

### SUMMARY OF THE INVENTION

The present invention is directed to a door assembly and door assembly side column and guide track configuration which provides maximum breakaway ability, while also ensuring that the door panel is taut and has full wind load or pressure differential resistance along a least a portion of the guide track.

According to one aspect of the invention, a door assembly is provided. The door assembly includes a door panel having a top edge, a bottom edge, a first vertical edge and a second vertical edge, with the door panel being fixed proximate the top edge to a drum. The door panel winds onto and unwinds from the drum in order to open and close a doorway. The door assembly further includes a first side column and a second side column, the first side column being positioned proximate a first side of the doorway and the second side column being positioned proximate a second side of the doorway. The first side column and the second side column each include a guide track, with each guide track having a first portion and a second portion. The first portion of each guide track defines a first guide channel having a first depth extending from a rear portion of each guide track to a first engagement portion of each guide track, with the first engagement portion of each guide track further defining a first gap so that the door panel may extend from the doorway through the first gap into the first guide channel. The second portion of each guide track defines a second guide channel having a second depth extending from the rear portion of the guide track to a second engagement portion of each guide track, with the second engagement portion of each guide track further defining a second gap so that the door panel may extend from the doorway through the second gap into the second guide channel. The second depth, i.e. the depth of the second guide channel, may be less than the first depth, i.e. the depth of the first guide channel. In order to further increase the wind load and pressure differential resistance in the second portion of the guide track, the first gap may have a first width and the second gap may have a second width, with the second width being narrower or less than the first width.

Each guide track may further include a transition portion located between the first portion and the second portion. The transition portion may include a transition engagement portion defining a transition gap, and a transition guide channel which has a transition guide channel depth which may decrease from a top portion of the transition guide channel to a bottom portion of the transition guide channel or vice versa. The transition guide channel depth may be equal to the first depth at a top portion of the transition guide channel, for example, and may reduce to match to the second depth at a bottom portion of the transition guide channel. Where each guide track includes a transition channel, the first gap may have a first gap width, the second gap may have a second gap width, and the transition gap may have a transition gap width. Again, the second gap width may be narrower or less than the first gap width. The transition gap width may begin at the first gap width at a top portion of the transition portion and reduce to match the second gap width at a bottom portion of the transition portion. Alternatively, the transition gap width may be equal to first gap width, may be equal to the second gap width, or may be a third gap width different than the first or second gap width.

In order to form the second portion of each guide track, the second portion of each guide track may be molded during manufacture so that the second engagement portion is positioned closer to the rear portion of each guide track than the first engagement portion. Each guide track may be molded such that only the engagement portions are formed on the interior of the guide track, or the second portion of each guide track may include a body or filler which extends between the second engagement portion formed and an outer edge of each guide track, filling same or all of the area between the second engagement portion and the outer edge of the guide track. Where a body is formed, the body may further define a body gap from the second engagement portion to the outer edge of the guide track so that the door panel may extend through from the doorway through the body gap and the second gap into the second guide channel. The width of the body gap may be equal to the width of the second gap, may be narrower than the width of the second gap, or may be wider than the width of the second gap.

Rather than being molded during manufacture the guide tracks may have a continuous engagement portion, and the door assembly may include at least two inserts, with one insert from the at least two inserts being inserted into each guide track to form the second portion of each guide track. Each insert may provide the second engagement portion positioned further inside the guide track than the first engagement portion so that the second engagement portion is positioned closer to the rear portion of each guide track than the first engagement portion. Each insert may include only a second engagement portion, or alternatively may include a body or filler which fills the area in the guide channel between the first engagement portion to the second engagement portion along the portion of the guide track in which the insert is placed. The body may further define an insert gap so that the door panel may extend through from the doorway through the insert gap and the second gap into the second guide channel. The width of the insert gap may be equal to the width of the second gap, may be narrower than the width of the second gap, or may be wider than the width of the second gap.

Each side column of the door assembly may further include a guide track retainer mounted to each respective guide track. Each guide track retainer may be made from a different material than each guide track, for example, the material of each guide track may be more flexible than the material of each guide track retainer. Each guide track retainer may extend a first distance across the first potion of an associated guide track and a second distance across the second portion of the associated guide track, with the first distance being different than the second distance. Each guide track retainer may extend across the second portion of an associated guide track a distance which at least reaches the second engagement portion.

In some embodiments of the invention, the first portion of each guide track may have a first flexibility and the second portion of each guide track may have a second flexibility, with the first and second flexibilities being different. The first portion flexibility may be more or less flexible than the second portion flexibility. Likewise, the first engagement portion may have a different flexibility than the second engagement portion.

Other advantages and aspects of the present invention will become apparent upon reading the following description of the drawings and detailed description of the invention.

### BRIEF DESCRIPTION OF THE DRAWINGS

FIG. 1 shows a door assembly according to an embodiment of the invention;

FIG. 2 shows an embodiment of door panel 12 from FIG. 1 isolated from the door assembly;

FIGS. 3A-C show a front prospective view, a back perspective view, and a side elevation view of portion R of door panel 12 in FIG. 2, respectively;

FIG. 3D shows an isolated side elevation view portion R of door panel 12 in FIG. 2 when door panel 12 is wound about drum 14;

FIG. 4 shows portion C of the guide tracks shown in FIG. 12;

FIG. 5 is a perspective view of portion C of the guide track shown in FIG. 4 with guide track 20b removed;

FIG. 6 is a side view of portion C of the guide track shown in FIG. 4 with guide track 20b removed;

FIGS. 7 shows cross-sections taken along line D-D in FIG. 4 with door panel 12 shown therewith;

FIGS. 8A-B show cross-sections taken along line H-H in FIG. 4 with door panel 12 shown therewith showing various embodiments of the engagement portion 70b shown in FIGS. 5 and 6;

FIG. 8C shows an exemplary guide track configuration from portion 63 down in FIG. 1 with the door panel removed;

FIG. 9 shows a door assembly according to an embodiment of the invention;

FIG. 10 shows an embodiment of door panel 112 from FIG. 9 isolated from the door assembly;

FIG. 11 shows an embodiment of door panel 112 from FIG. 1 isolated from the door assembly;

FIG. 12 shows an embodiment of door panel 112 from FIG. 1 isolated from the door assembly;

FIGS. 13A-F show cross-sections taken along the lines AA-AA in FIGS. 10 and 11 showing various embodiments of thickened bodies in FIGS. 10 and 11;

FIG. 14 shows a cross-section taken along the line BB-BB in FIG. 12;

FIG. 15 shows portion CC of the guide tracks shown in FIG. 9;

FIG. 16 is a perspective view of portion CC of the guide track shown in FIG. 15 with guide track 120b removed;

FIG. 17 is a side view of portion CC of the guide track shown in FIG. 15 with guide track 120b removed;

FIGS. 18A-B show cross-sections taken along line DD-DD in FIG. 15 with door panel 12 shown therewith showing various embodiments of the engagement portion 170a shown in FIGS. 16 and 17;

FIGS. 19A-B show cross-sections taken along line HH-HH in FIG. 15 with door panel 12 shown therewith showing various embodiments of the engagement portion 170b shown in FIGS. 16 and 17; and

FIG. 20 shows an exemplary guide track configuration from portion 163 down in FIG. 9 with the door panel removed.

### DETAILED DESCRIPTION OF THE PRESENT INVENTION

While the present invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

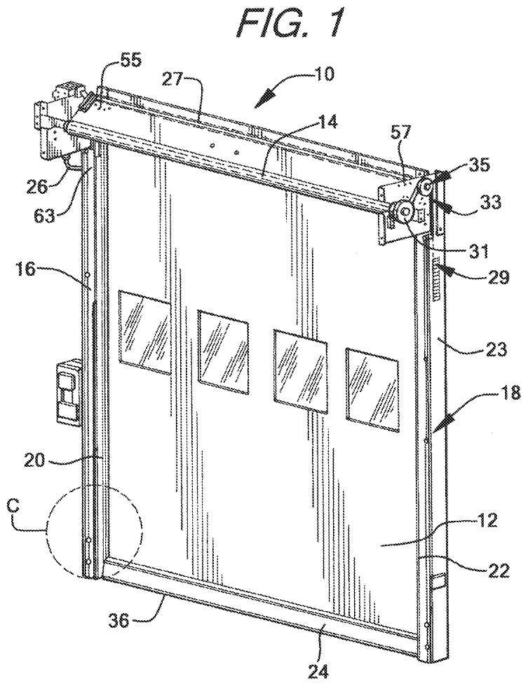

FIG. 1 shows an embodiment of a door assembly as contemplated by the invention. As seen in FIG. 1, door assembly 10 includes a door panel 12, a roll drum 14 onto which the door panel winds and from which the door panel unwinds to open and close the door, respectively. Side columns 16, 18 having guide tracks 20, 22 are provided along opposing vertical sides of doorway 24 to guide the door panel as it is wound and unwound from drum 14, opening and closing the door respectively.

In order to facilitate the movement and winding and unwinding of the door panel in the embodiment of door assembly 10 shown in FIG. 1, a motor 26 may be provided, with the motor being connected to a drive drum 27 to drive the door panel between the open and closed position. Motor 26 may have a gear or sprocket directly coupled to a corresponding gear or shaft on drive drum 27, or may be coupled using a flexible connection means such as a cable, chain, rope or the like. The motor may also be directly coupled to the drive drum. Regardless of how coupled, motor 26 should be configured to rotate drive drum 27 in two directions to facilitate the opening and closing and winding and unwinding of door panel 12. For example, activation of the motor in a first mode or direction may cause the drive drum to rotate in the counterclockwise direction to drive the door panel upwards and open the door, and activation of the motor in a second mode or direction may cause the drive drum to rotate in the clockwise direction to drive the door panel downwards and close the door.

Drive drum 27 and roll drum 14 should be arranged to rotate in the same direction when door panel 12 is winding or unwinding. For example, when door panel 12 is winding and the door is being opened, roll drum 14 and drive drum 27 may be configured to rotate in the counterclockwise direction, while both roll drum 14 and drive drum 27 may rotate in the clockwise direction to unwind the door panel and close the door.

In order to ensure that a tight roll is formed on roll drum 14, counterweight 29 may be provided and connected to a spool 31 by a flexible engagement member 33, which may be, for example, a strap or belt. Spool 31 may be coupled to rotate along with roll drum 14, with the flexible engagement member carrying the counterweight being wound about spool 31 in the opposite direction door panel 12 is wound on roll drum 14. For example, as door panel 12 is wound and raised when roll drum 14 is rotated in the counterclockwise direction, flexible engagement member 33 should be configured to unwind and lower counterweight 29 from spool 31 as spool 31 is rotated in the counterclockwise direction with the roll drum. Similarly, as the door panel is unwound and lowered when the roll drum is rotated in the clockwise direction, the flexible engagement member should be configured to wind and raise the counterweight to the spool as the spool is rotated in the clockwise direction with the roll drum. A free-moving pulley 35 may be connected proximate an end of drive drum 27 to provide further guidance for strap 33. Pulley 35 should be free moving and not attached to drive drum 27 in a manner in which motor 26 or drive drum 27 control or influence the rotation of pulley 35—movement of the flexible engagement member 33 as it is guided over pulley 35 is wound and unwound should cause pulley 35 to rotate.

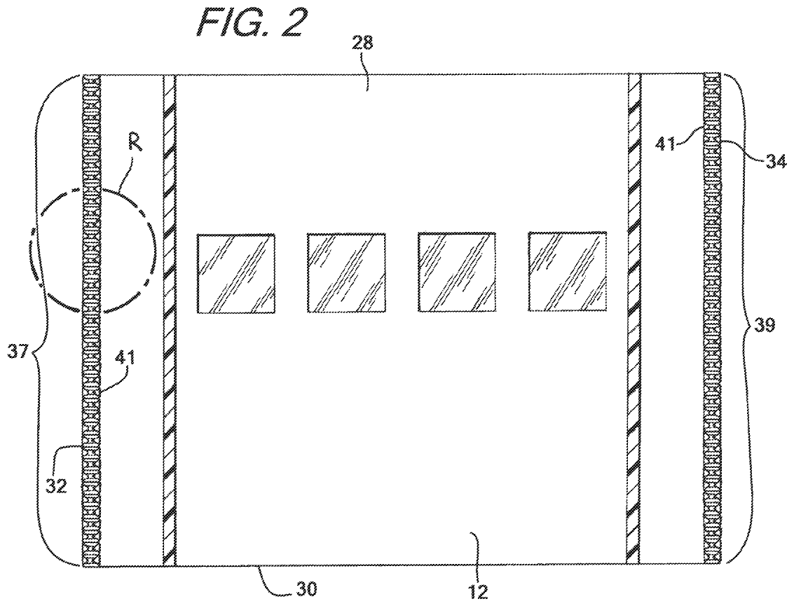

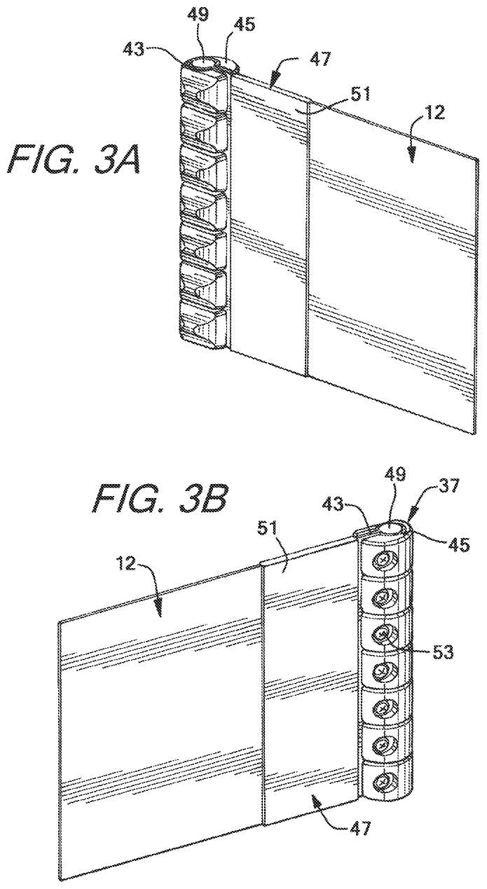

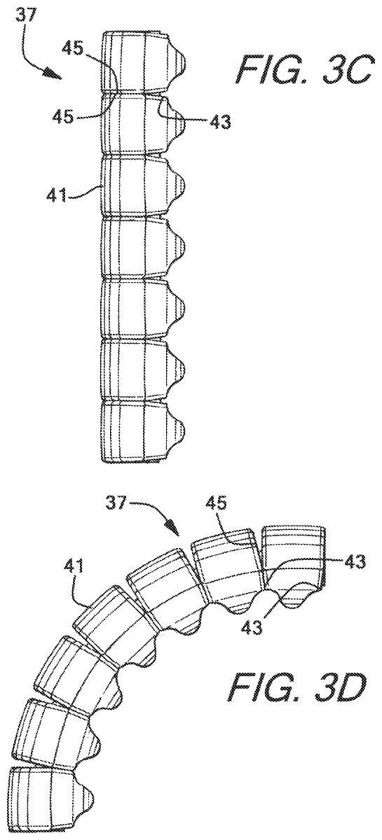

An embodiment of door panel 12 isolated from door assembly 10 in FIG. 1 can be seen in FIG. 2, while a front perspective view close up of portion R of door panel can be seen in FIG. 3A, a rear perspective view of portion R of the door panel can be seen in FIG. 3B, and a side view of portion R of door panel 12 can be seen in FIG. 3C. As seen in FIG. 2, door panel 12 includes a top edge or portion 28, a bottom edge or portion 30, and opposing vertical side edges 32, 34 which extend vertically between the top edge and the bottom edge of the door panel. Top edge or portion 28 of door panel 12, and optionally or alternatively some amount of door panel, is mounted to roll drum 14, while bottom edge or portion 30 contacts a lower boundary 36 (shown in FIG. 1) of doorway 24 when the door panel is in the fully closed position. Aligned along each vertical edge 32, 34 of door panel 12 are columns of drive teeth 37, 39 which each comprise a plurality of individual drive teeth 41 which each abut the drive teeth immediately above and below in the drive tooth column. A first portion 43 (shown in FIGS. 3A-C) of each drive tooth abuts the first portion of adjacent drive teeth when wound about roll drum 14, and a second portion 45 (shown in FIGS. 3A-C) of each drive tooth abuts the second portion of adjacent drive teeth when unwound from drum 14 and being guided and/or contained in guide track 20 or 22. The abutting of adjacent first portions of drive teeth 41 can be more easily seen in FIG. 3D which shows an isolated side view of the exterior of portion R of the door panel as it would look when the door panel is wound about a drum.

As most easily seen in FIGS. 3A and 3B, in order to facilitate attachment of the individual drive teeth, a keder 47 comprising a flexible cable or body 49 wrapped in a flap of material 51 may be provided along each vertical edge of the door panel. The flexible cable or body 49 may be a constant length body or cable which does not stretch or shorten as the door panel is wound and unwound, with flap 51 surrounding the cable and being fixed directly to the door panel. Each drive tooth 41 within drive tooth columns 37, 39 may then be fixed directly to the cable using a fastener 53 (shown in FIG. 3B) which may be a screw, rivet, bolt or the like, to maintain the position of the drive teeth relative to each other in the drive tooth columns, and to ensure that the first and second portions of each drive tooth abut the first and second portions of adjacent drive teeth as necessary.

In order to facilitate the driving of the door panel, drive sprockets 55, 57 may be fixed on drive drum 27 and configured to engage drive tooth columns 37, 39 and individual drive teeth 41 to push the drive tooth columns downwards when the door panel is being unwound as the door is closed, and pull the drive tooth columns upwards when the door panel is being wound and the door is opened. A more detailed explanation of the engagement of drive tooth columns, individual drive teeth, and drive sprockets can be found in U.S. Pat. Pub. No. 2020/0173231 which is fully incorporated herein by reference.

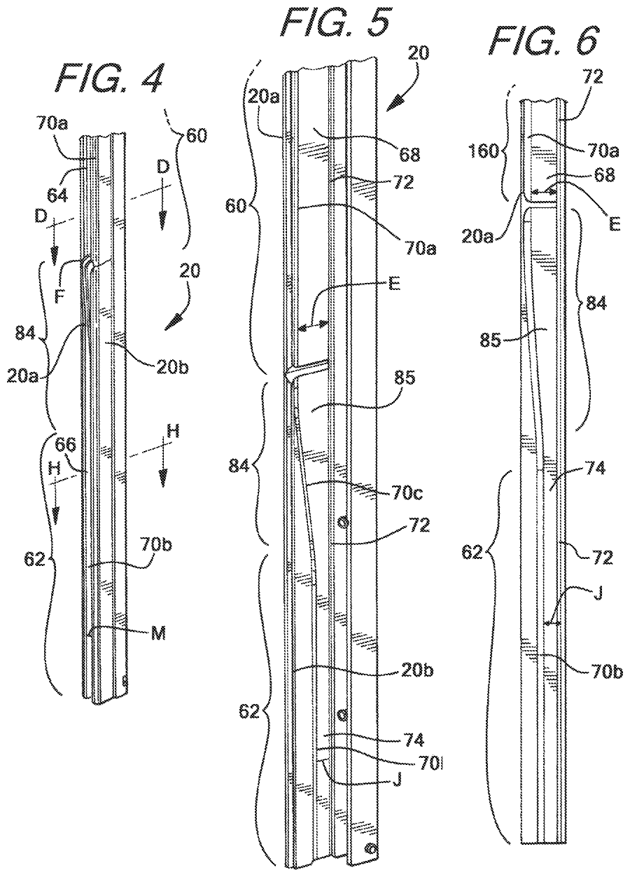

FIGS. 4-6 show portion C of guide track 20 from FIG. 1. It should be understood that though guide track 20 will be primarily discussed herein, all elements discussed with respect to guide track 20 will likewise be found in guide track 22. As seen in FIG. 1, guide track 22 may further include an outer channel 23 in which counterweight 29 and flexible engagement member 33 may be housed and travel as the counterweight is wound and wound from spool 31.

As seen in FIG. 4, portion C of guide track 20 includes two tracks, 20a, 20b, as well as an upper portion 60 and a lower portion 62, with upper portion 60 extending vertically along a majority or the entirety of guide tracks 20, from a top portion or area 63 (see FIG. 1 for example) of the guide tracks to some portion above lower portion 62 or any transition portion as discussed herein. Upper portion 60 of tracks 20a, 20b includes an engagement portion 70a which may engage the drive tooth column mounted to one opposing vertical edge of the door panel when, for example, a wind load is applied to the door panel, or a pressure differential is applied to opposing sides of the door panel. A gap 64 is bound by engagement portions 70a of tracks 20a, 20b through which the door panel extends from the doorway and into the upper portion of the guide track.

Lower portion 62 of tracks 20a, 20b likewise include engagement portions, in this case engagement portions 70b. The engagement portions 70b define a gap 66 through which the door panel extends from the doorway and into the lower portion of the guide track. Gap 64 and gap 66 may have the same dimension, or different dimensions depending on the requirements of the door assembly. For example, for door assemblies in locations with potentially high winds and/or high-pressure differentials on opposing sides of the door panel, gap 66 in the lower portion of the guide track may be narrower or smaller than gap 64 in order to better prevent any drive teeth from escaping the lower portion of the guide track in response to a potentially high wind load applied to the door panel, and/or high-pressure differential being applied to opposing sides of the door panel. Inasmuch as wind load, for example, increases on the door panel as the door panel is closed as more surface area of the door panel is engageable by wind or a gust, providing a more secure engagement between the drive teeth columns within the side columns at the lower portion of the doorway helps prevent disengagement of the door panel from the side columns as the door panel approaches and reaches the fully closed position.

An interior portion of tracks 20a, 20b further define a guide channel which can be partially seen in FIGS. 5 and 6 which are perspective and front views of guide track 20 in FIG. 4, respectively, with a portion of track 20b removed. As seen in FIGS. 5 and 6, guide channel 68 in upper portion 60 of guide track 20 is bound by engagement portion 70a on the doorway side of the guide track, and by a rear portion 72 of the guide track on the portion of the guide track remotely located from the doorway.

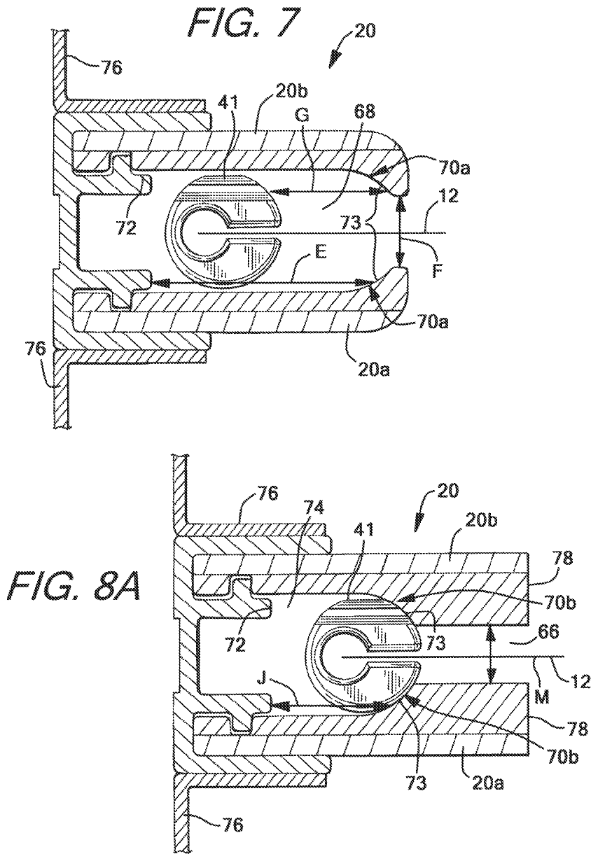

The configuration of upper guide channel 68 can be more clearly seen in FIG. 7 which is a cross-section taken along the line D-D in FIG. 4 with door panel 12 shown therewith. As seen in FIG. 7, engagement portions 70a may be formed as a curved seat 73 or other shape which has a geometry which cooperates or matches the geometry of the individual drive teeth 41 in the drive tooth column guided within the guide track. For example, when the guide teeth are rounded as shown in FIGS. 3A-D, the curved seats may have a matching radius to receive the drive teeth. The shape of engagement portions 70a may take any form, so long as it substantially matches the geometry of the drive teeth or other wind lock mounted along the vertical edge of the guided door panel in the given door assembly. Regardless of the shape of the drive teeth and matching engagement portions, the engagement portions form a first boundary of guide channel 68. Likewise, rear portion 72 may take any form so long as it bounds the channel on a second boundary opposite the first so that the vertical edge of the door panel cannot escape through the back of the guide track.

Guide channel 68 is defined between engagement portions 70a and rear portion 72 at a depth E, with gap 64 having a width F defined between engagement portions 70a of guide tracks 20a, 20b. Upper guide channel 68 extends along a majority of guide track 20 and within the upper portion of the guide track, door panel 12 and the mounted drive teeth are free to move between the engagement portion and rear portion as the door panel is guided within the guide track as the door panel wound and unwound from roll drum 14. In an unloaded state as seen in FIG. 7, for example, when no or very little wind load is applied to the door panel, an interior channel gap G exists between the drive teeth and the engagement portion to reduce friction as the door panel is moved within the guide channels between the opened and closed, or wound and unwound, positions.

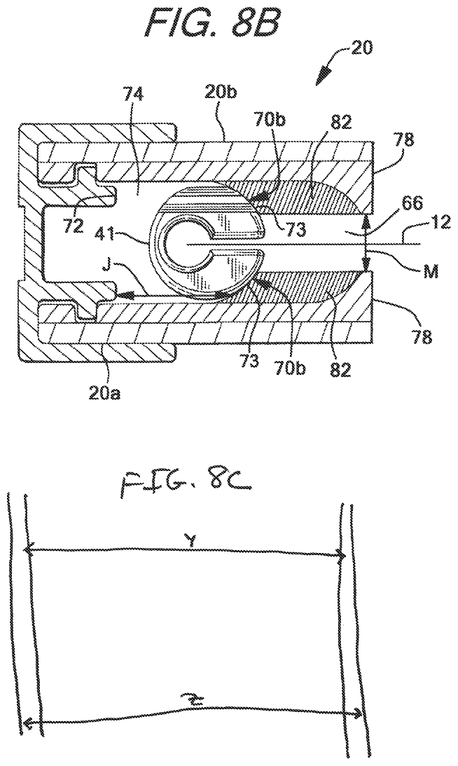

In order to remove slack from the door panel and increase wind load resistance as the door panel approaches a substantially closed position in the present embodiment, as seen in FIGS. 5 and 6, and more clearly seen in FIGS. 8A and 8B which are a cross-section taken along the line H-H in FIG. 4 with door panel 12 shown therewith, lower portion 62 of guide track 20 defines guide channel 74 which has a reduced depth J therein to pull the teeth outwards, away from the doorway and gap 66, and closer to rear portion 72.

In order to reduce the depth of guide channel 74 from guide channel 68 defined within the upper portion of guide track 20 and pull the vertical edges of the door panel outwards, engagement portions 70b may be positioned inwards in the guide tracks, away from the doorway and closer to the rear portion relative to engagement portions 70a, in order to engage the drive tooth columns and force the drive tooth column, along with the door panel to which the drive teeth 41 are mounted, outwards from the doorway and towards rear portion 72. Guide channel 74 in lower portion 62 of guide track 20 is defined between the engagement portions 70b and the rear portion of the guide track, with the depth of the guide channel 74 being reduced to depth J. Width M of gap 66 between the engagement portions 70b may also optionally be reduced from width F between engagement portions 70a in upper portion 60 of guide track 20. As discussed further herein, a transition portion 84 may be provided in each guide track between upper portion 60 and lower portion 62, to provide a smooth transition from the wider upper guide channel depth to the narrower lower guide channel depth.

Reducing the depth of the guide channel in the lower portion of the guide tracks by positioning the engagement portions 70b closer to the rear portion, forces the portion of the drive tooth column fixed proximate the lower portion of the vertical edge to engage the engagement portion and pushes the vertical edge of the door panel towards the rear portion of the guide track, away from the gap. Forcing the drive tooth column on the door panel outwards, away from the gap and towards the rear portion of the guide track, causes the door panel to become more taut, reducing any sag or looseness in the across the door panel and/or in the bottom edge of the door panel, and increases the wind load resistance of the door panel, as the drive teeth are required to overcome the force generated by the friction of the drive teeth moving within the guide channel while engaged, as well as the force required to slip through a gap created in the middle of the guide tracks rather than the end of the guide tracks. When gap 66 is a reduced width, greater force is required to pull the drive tooth column or other wind lock element through the gap to disengage the guide track. The effect of the upper and lower portions of the door panel can be seen in FIG. 8C, wherein the distance between outer edges of the door panel may be separated by a distance Y, just inside in the outer edge of the guide tracks in the upper portion of the guide tracks when allowed to freely hang or move in the guide tracks, while the outer edges of the door panel may be forced into a greater separation distance Z by when the drive teeth are engaged in the lower portions of the guide tracks and forced outwards, away from each other, and towards the rear portion of the guide track.

Guide track retainers 76 may be utilized in door assembly 10 and formed as part of side columns 16, 18. Providing guide track retainers which are made from a material which is stiffer or less flexible than the guide tracks, for example steel or metal guide track retainers and UHWM polymer guide tracks, the portion of the guide tracks to which the guide track retainers are mounted may be stiffer and more difficult for the drive tooth columns or other wind lock elements and door panel to disengage from. Where guide track retainers are utilized, the guide track retainers may extend a uniform distance across the guide tracks from top to bottom, or may alternatively extend a different amount across upper portion 60 of the guide tracks than across lower portion 62 of the guide tracks. For example, guide track retainers may only extend a small distance across upper portion 60 to merely help maintain the position of the guide tracks while providing minimal resistance, and across a larger distance across lower portion 62 of the guide tracks in order to add stiffness to the tracks and help increase wind load resistance in the guide tracks at lower portion 62 and help prevent the door panel from escaping the guide tracks. Guide track retainers 76 may, for example, extend across an outer portion of guide tracks 20a, 20b a distance at least equal to depth J of guide channel 74 in lower portion 62 of the guide tracks.

The wind load resistance may be further be controlled by providing a body or insert between engagement portion 70b and outer edges 78 of guide track 20 or between engagement portion 70b and first engagement portion 70a of guide track 20, or by leaving the area empty so that only the engagement portion 70b provides thickness to prevent the drive teeth column from escaping.

Engagement portion 70b may be positioned deeper in guide tracks 20 and closer to rear portion 72 in lower portion 62 of guide tracks 20, 22 by directly molding the lower section of the guide track with a deeper or more inwardly positioned engagement portion relative to the top portion, or by providing an insert or inserts for each guide track which fit within the track and provide a new engagement portion at lower portion 62. Tracks which are directly designed to have the second engagement portion formed with the track may be any of machined or milled UHMW polymers as seen in FIG. 8A, molded UHWM polymers.

The use of separate insert 82 fixed within the guide tracks can be seen in FIG. 8B. Inserts are particularly beneficial during the manufacturing process, as a continuous guide track having a substantially uniform guide track may be created, with inserts provided to slip into the track as desired or required anywhere along the track to reduce the depth of the guide channel along the section of track the insert is positioned, i.e. lower portion 62. The inserts may also be configured to change the width of the gap through which the door panel has to pass to escape. By using inserts, various points along the track can be modified to tighten the door panel in place, and the reduction in the channel depth can be more easily controlled as inserts having an engagement portion which narrows the guide channel different amounts can be used at different points along the track.

Utilizing inserts also allows for the depth of the guide channel to be modified over time, if necessary. For example, in guide tracks which are initially placed in a high-traffic, low wind or low-pressure differential environment, a minimal insert may be utilized within the track so that high level of guide channel width and breakaway ability of the door panel is maintained along the entire length of the guide track and doorway opening. If the wind load and/or pressure differential realized by the door panel increases over time, and/or the traffic at the door location decreases over time, new inserts may replace the old inserts within the guide tracks at selected positions, for example the bottom 12-36 inches of the track, to further narrow the guide channel and better hold the door panel in place over that portion of the guide tracks.

Inserts may be inserted into each guide track by, for example, opening or holding the gap in the track open at the desired location of the insert to allow the insert to be slid into the track. Alternatively, one of the tracks, guide track 20b for example, may be removed to allow positioning of the insert in the desired location before track 20b is reattached. The inserts may also be slid in from a top or bottom portion of the track and positioned along the track as desired. When positioned along the bottom 12-36 inches of the guide track, the inserts may be allowed to merely rest on lower boundary 36 of doorway 24 or area surrounding the doorway. The inserts may also be fixed within the guide tracks at any desired location, including the bottom 12-36 inches of the guide track, using adhesives or fasteners such as screws, bolts, rivets, or the like.

In order to ensure a smooth transition between upper portion 60 and lower portion 62 of guide tracks 20, 22, and in order to eliminate any edges on which the door panel and any drive teeth or other wind lock may become stuck as the door panel moves between guide channels 68, 74, as mentioned herein and seen in FIGS. 5 and 6, a transition portion 84 of the guide track may be provided having a transition channel 85. When a narrower guide channel is used at the bottom of the guide tracks, the depth of the transition guide channel should begin at approximately depth F of guide channel 68 at the upper guide channel 85 and gradually narrow the guide channel down to approximately the narrower depth J proximate at the lower portion of guide channel 85 at the upper most portion of guide channel 74. Approximate depth in this case may be equal to or slightly smaller or larger than, such that no lip or edge is created on which a drive tooth or the like may become stuck as the door panel opens and closes and passes the area where the channel transitions from guide channel 68 to guide channel 85 to guide channel 74. Engagement portion 70c of transition portion 84 may engage and gradually push the drive tooth columns outward from the doorway and gap, and towards rear portion 72, as the door panel closes, gradually removing the slack and tightening the door panel before finally stopping at depth J and passing the drive tooth column off to engagement portion 70b in lower portion 62 of the guide tracks.

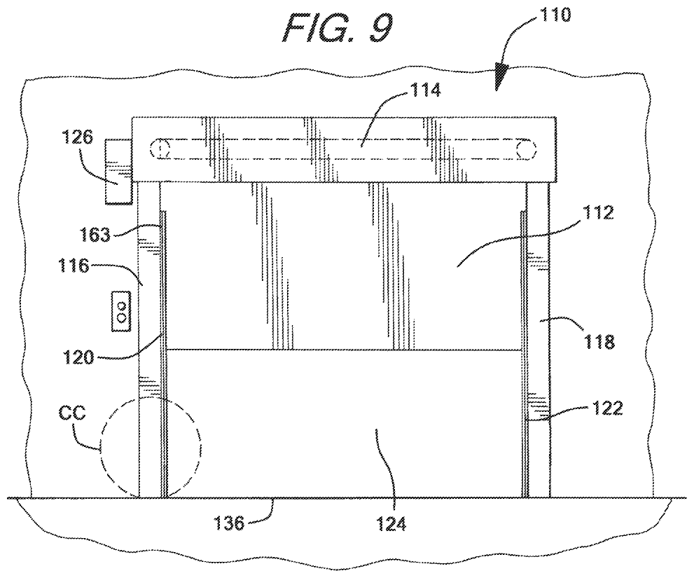

FIG. 9 shows a second embodiment of a door assembly contemplated by the invention in which rather than have drive tooth columns aligned along each vertical edge, one or more thickened bodies are provided along each vertical edge to both provide wind load resistance to the door panel. As seen in FIG. 9, door assembly 110 includes door panel 112 which is wound and unwound from drum 114 to open and close the door, respectively. Door assembly 110 further include side columns 116, 118, having guide tracks 120, 122 respectively, with the side columns forming the outer vertical edges of doorway 124, and guide tracks 120, 122 guiding the outer vertical edges of the door panel as it winds and unwinds from the drum to open and close the door. In order to drive drum 114, motor 126 may be coupled to drum 114. Motor 126 may have a gear or sprocket directly coupled to a corresponding gear or shaft on drum 114, or may be coupled using a flexible connection means such as a cable, chain, rope or the like. Regardless of how coupled, motor 126 should be configured to rotate drum 114 in two directions to facilitate the winding and unwinding of door panel 112. For example, activation of the motor in a first mode or direction may cause the drum to rotate in the counterclockwise direction to wind up the door panel and open the door, and activation of the motor in a second mode or direction may cause the drum to rotate in the clockwise direction to unwind the door panel and close the door. Note, unlike the previous embodiment of the invention, in the current embodiment of the invention a single drum may be used as both the roll drum and the drive drum.

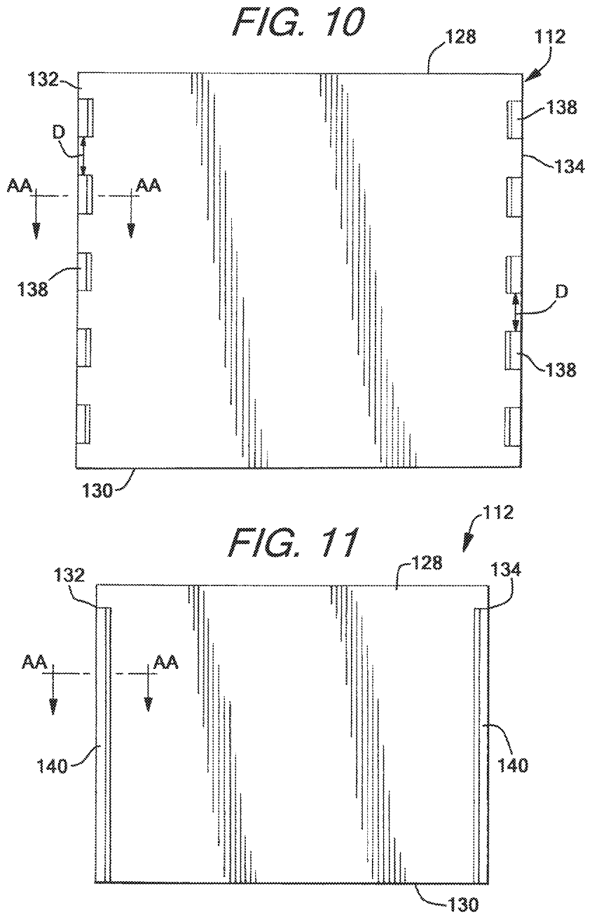

Exemplary door panels 112 which may be utilized with door assembly 110 can be seen in FIGS. 10-12 which show various embodiments of door panel 112 isolated from door assembly 110. As seen in FIGS. 10-12, each door panel 112 may include a top portion or edge 128, a lower edge or portion 130, and opposing vertical edges 132, 134 extending between the upper portion or edge and the lower edge or portion. The top portion or edge 128, and optionally or alternatively, some portion of the adjacent door panel, is fixed to drum 114 while lower edge or portion 130 contacts a lower boundary of the doorway (boundary 136 shown in FIG. 9, for example), such as a floor, when the door panel is fully unwound and the door panel is fully closed.

In order to enhance engagement and guidance of the door panel when integrated with the door assembly, as well as provide wind load and/or pressure differential resistance and prevent the door panel from escaping the guide tracks and disengaging from the door assembly in response to a wind load being applied to the door panel, for example, one or more thickened bodies may be fixed proximate each vertical edge 132, 134 of the door panel. As seen in FIG. 10, multiple thickened bodies 138 spaced apart by a distance D may be attached proximate each vertical edge to better facilitate disengagement of the door panel from the guide tracks and door assembly if the door panel is impacted by, for example, a vehicle or items being carried by a vehicle. Alternatively, as seen in FIG. 11, a single thickened body 140 may extend along at least a majority of each vertical edge to facilitate better wind load resistance at the expense of disengageability if the door panel is impacted.

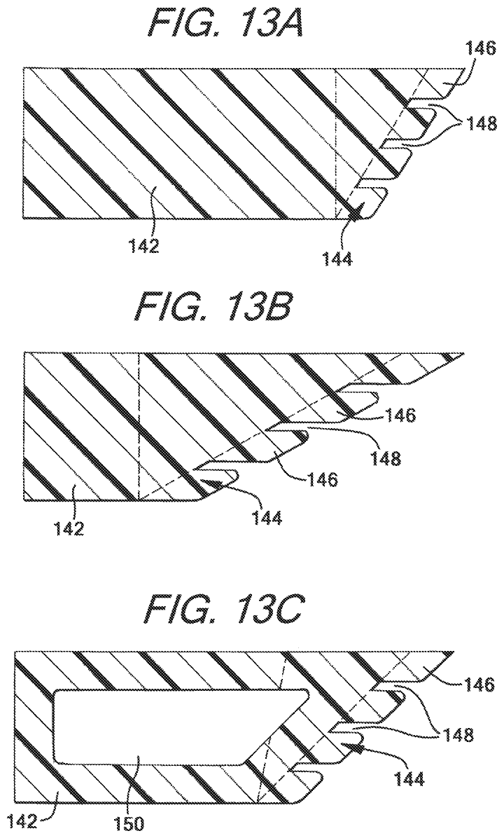

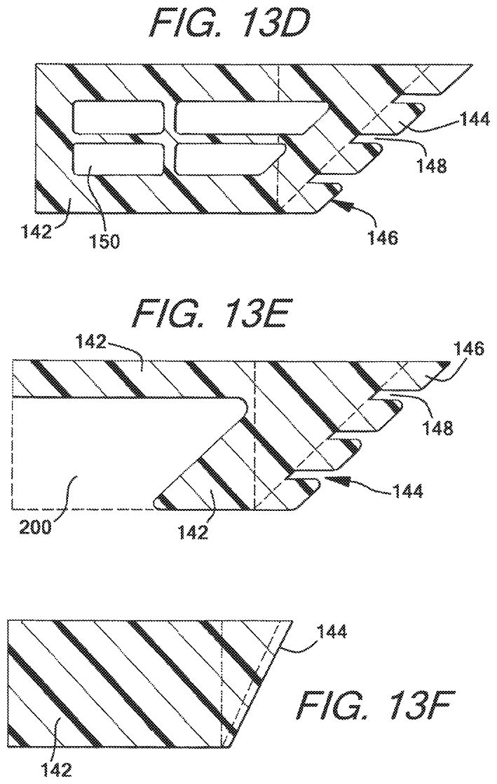

Exemplary cross-sections of thickened bodies 138 and a single continuous thickened body 140 taken along line AA-AA in FIGS. 10 and 11 can be seen in FIGS. 13A-F. Whether segmented or broken part, the thickened bodies may include a body portion 142 and angled or engagement portion 144 which is positioned and configured to engage the guide track in response to a wind load and/or a pressure difference existing on opposing sides of the door panel. Utilizing an angled portion helps facilitate disengagement of the door panel in response to the door being impacted by a vehicle or the like, as the angled portion may wedge into a gap formed in the guide track and push the gap open to allow the door panel and remaining thickened edge to escape the guide track.

Angled or engagement portion 144 may be solid and continuous, as seen in FIG. 13F, or may include one or more ribs 146 having gaps 148 therebetween to allow for compression of the ribs and the angled or engagement portion when the door panel is impacted and engages the engagement portion of the guide track to further facilitate disengagement of the door panel from the guide tracks and door assembly. As seen in FIGS. 13A, 13B, and 13F the body portion may be solid. Alternatively, in order to allow for more compression of the thickened bodies and better facilitate disengagement from the guide tracks and door assembly in response to an impact hit, open channels 150 may be provided in the body portion as seen in FIGS. 13C and 13D. As seen in FIG. 13E, rather than be solid or having open channels formed therein, a portion 200 of the body portion may be simply removed behind the angled or engagement portion so that only the angled portion must squeeze through the gap to escape the guide track if the door panel is impacted.

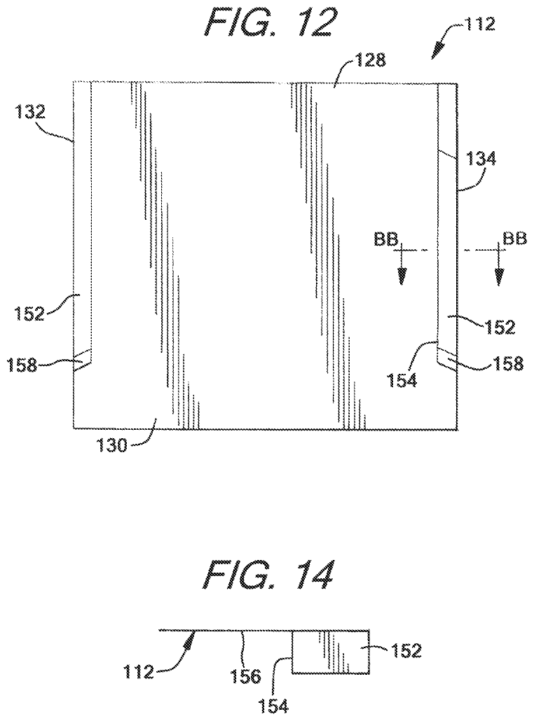

Rather than have an angled portion, the door panel shown in FIG. 12 may have only the thickened body portion and no angled portion. As better seen in FIG. 14 which is a cross-section taken along line BB-BB of the door panel shown in FIG. 12, in a further embodiment, thickened body 152 may include a body portion and have an engagement edge or portion 154 which is perpendicular to face 156 of the door panel. Rather than extending at an angle from the face of the door panel as with thickened bodies 138, 140, engagement edge or portion 154 extends vertically from the face of the door panel to better prevent door panel 112 from escaping the guide tracks and door assembly in response to a wind load or pressure differential.

To facilitate disengagement of the embodiment of door panel 112 shown in FIG. 12 in response to an impact hit on the door panel, the lower most portion of thickened body 152 may include a portion 158 which is angled outwards from engagement edge or potion 154 towards the outer vertical edge of the door panel, with the portion 158 also being beveled with respect to face 156 of the door panel. Like the angled portion 144 in the embodiments of the door panel shown in FIGS. 10 and 11, portion 158 may act to wedge into the gap of the guide track and push the guide track open slightly to help the remainder of thickened body 152 escape the guide track and avoid unnecessary damage to the door panel, guide track, side column, thickened body, or any other portion of door assembly 110 in response to the door being impacted by a vehicle, for example.

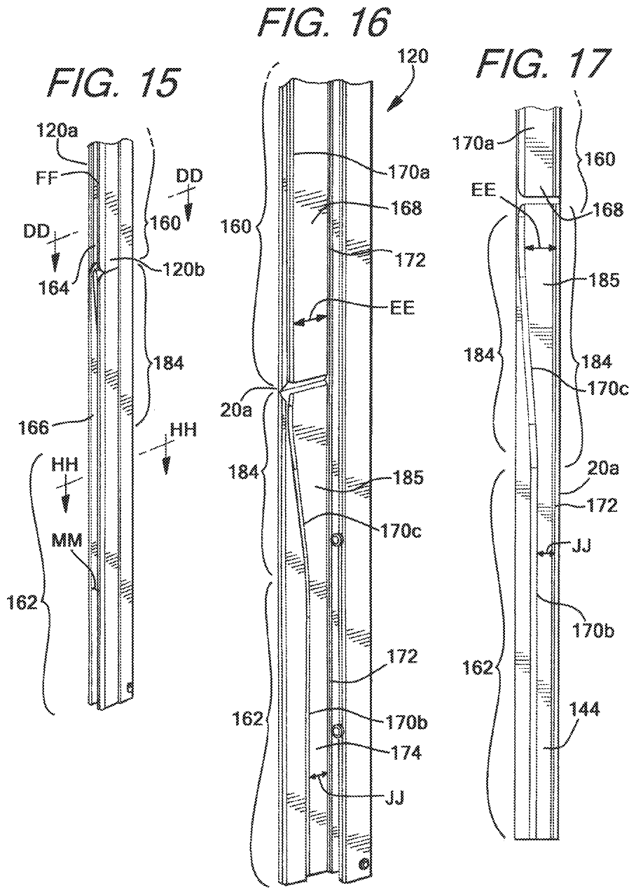

Regardless of the differences in door panels 112, door assembly 110, guide tracks 120, 122 are substantially identical and can better seen in FIGS. 15-17 which show a view of portion CC of guide track 120. It should be understood that though guide track 120 will be primarily discussed herein, all elements discussed with respect to guide track 120 will likewise be found in guide track 122 except where specifically identified herein.

As seen in FIG. 15, guide track 120 includes two tracks, 120a, 120b, as well as an upper portion 160 and a lower portion 162, with upper portion 160 extending vertically along a majority or the entirety of guide tracks 120, from top portion or area 163 in FIG. 9 to lower portion 162 or a transition portion located therebetween. Upper portion 160 of tracks 120a, 120b include an engagement portion which may engage the thickened body mounted to one opposing vertical edge of the door panel, with a gap 164 being bound by tracks 120a, 120b through which the door panel extends from the doorway and into the upper portion of the guide track.

Similarly, tracks 120a, 120b of lower portion 162 define a gap 166 through which the door panel extends from the doorway and into the lower portion of the guide track. Gap 164 and gap 166 may have the same dimension, or different dimensions depending on the requirements of the door assembly. For example, for door assemblies in locations with high wind loads and/or a high pressure differential on opposing sides of the door panel, gap 166 in the lower portion of the guide track may be narrower or smaller than gap 164 in order to better prevent any thickened body from escaping the lower portion of the guide track in response to a wind load and/or high pressure differential being applied to opposing sides of the door panel.

An interior portion of tracks 120a, 120b further define guide channels which can be partially seen in FIGS. 16 and 17 which are perspective and front views of guide track 120 in FIG. 15, respectively, with track 120b removed. As seen in FIGS. 16 and 17, guide channel 168 in upper portion 160 of guide track 120 is bound by engagement portion 170a on the doorway side of the guide track, and by a rear portion 172 of the guide track.

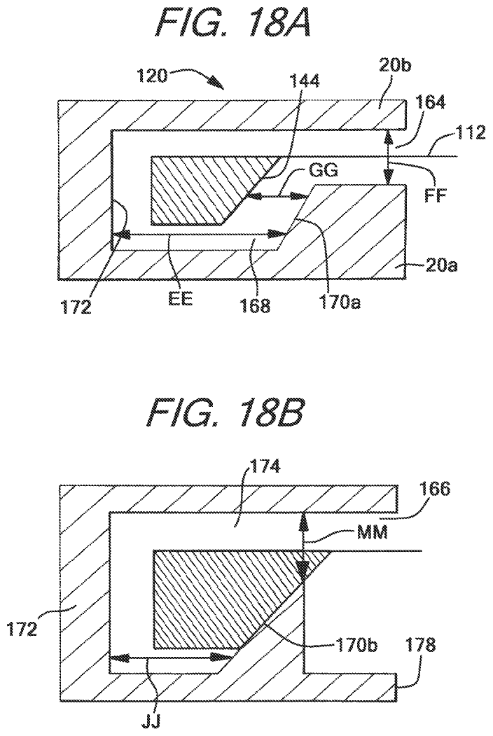

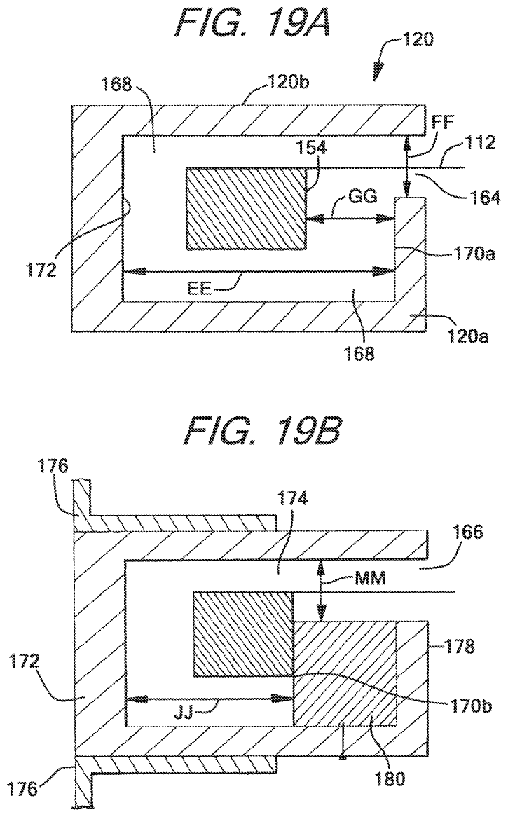

The configuration of upper guide channel 168 can be more clearly seen in FIGS. 18A and 19A which are cross-sections taken along the line DD-DD in FIG. 15 with door panel 112 shown therein. As seen in each of FIGS. 18A and 19A, engagement portion 170a in the guide tracks may differ in order to cooperate with or match the geometry of the various embodiments of thickened bodies discussed herein. However, regardless of the shape of the thickened body and cooperating or matching engagement portion, in each case the engagement portion forms the innermost boundary of guide channel 168. Engagement portion 170a may take any form, so long as it is substantially matches or complements the geometry of the thickened body mounted along the vertical edge of the guided door panel in the given door assembly. Likewise, rear portion 172 may take any form so long as it bounds the channel so that the vertical edge of the door panel cannot escape through the back of the guide track.

For example, FIG. 18A shows an engagement portion which would be utilized in a door assembly including door panels similar to those shown in FIGS. 10 and 11, with engagement portion 170a extending at an angle complementary to the angle of angled portion 144 of the thickened body or thickened bodies fixed to door panel 112 in FIGS. 10 and 11. Guide channel 168 is then defined between engagement portion 170a and rear portion 172 at a depth EE, with gap 164 having a width FF defined by engagement portion 170a of guide track 20 and track 20b.

By comparison, FIG. 19A shows an engagement portion which would be utilized in a door assembly including a door panel similar to that shown in FIG. 12, with engagement portion 170a extending at a right angle, matching the angle of engagement portion 154 of the thickened body or thickened bodies fixed to door panel 112 in FIG. 4. Guide channel 168 is then defined between engagement portion 170a and rear portion 172 at a depth EE, with gap 164 having a width FF defined by engagement portion 170a of guide track 120 and track 120b.

In each door panel embodiment, regardless of the shape of the engagement portion, the upper guide channel 168 which extends along a majority of guide track 120 has a depth EE and is bounded by the engagement portion and a rear portion of the guide track. Within the guide track, door panel 112 and any thickened bodies are free to move between the engagement portion and rear portion as the door panel is guided within the guide track as the door panel wound and unwound from drum 114. In an unloaded state as seen in FIGS. 18A and 19A, for example, when no or very little wind load is applied to the door panel, an interior channel gap GG exists between the thickened bodies and the engagement portion to reduce friction as the door panel is wound and unwound from the drum caused by engagement of the thickened bodies and engagement portion of the guide track.

In order to remove slack from the door panel and increase wind load resistance as the door panel approaches a substantially closed position, as seen in FIGS. 16 and 17, and more clearly seen in FIGS. 18B and 19B which are a cross-section taken along the line HH-HH in FIG. 15 with door panel 112 shown therewith, lower portion 162 of guide track 120 includes guide channel 174 at a reduced depth JJ therein to engage the thickened bodies and pull the thickened bodies outwards, away from the gap and closer to rear portion 172.

In order to reduce the depth of guide channel 174 from guide channel 168 defined within the upper portion of guide track 120, engagement portion 170b may be positioned inwards in the guide tracks, away from the doorway, in order to engage the thickened bodies and force the thickened bodies, along with the door panel to which the thickened bodies are mounted, outwards from the gap and closer to rear portion 172. Guide channel 174 in lower portion 162 of guide track 120 is still defined between the engagement portion of the guide track and the rear portion, however the depth of the guide channel is reduced to depth JJ by positioning the engagement portion inwards, towards the rear portion. Gap 166 is formed having a width MM between engagement portion 170b of guide track 120a and track 120b. Width MM may be equal to or smaller than width GG of gap 164.

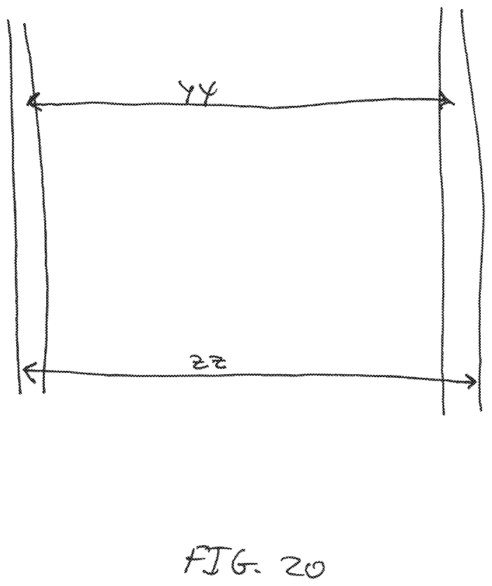

By reducing the depth of the guide channel by forming the engagement portion deeper into the guide track away from the doorway and closer to the rear portion, the engagement portion forces any thickened edge fixed proximate the vertical edge of the door panel towards the rear portion of the guide track, away from the gap. Forcing the thickened edges on the door panel outwards, away from the opening, causes the door panel to become more taught, reducing any sag or looseness in the across the door panel and/or in the bottom edge of the door panel, and increases the wind load resistance of the door panel, as the thickened edges or guide teeth are required to overcome the force required to slip through a gap created in the middle of the guide tracks rather than the end of the guide tracks. The effect of the upper and lower portions of the door panel can be seen in FIG. 20, wherein the distance between outer edges of the door panel may be separated by a distance YY, just inside in the outer edge of the guide tracks in the upper portion of the guide tracks when allowed to freely hang or move in the guide tracks, while the outer edges of the door panel may be forced into a greater separation distance ZZ by when the thickened bodies are engaged in the lower portions of the guide tracks and forced outwards, away from each other, and towards the rear portion of the guide track.

Guide track retainers 176 may optionally be formed as part of side columns 116, 118. By providing guide track retainers which are made from a material which is stiffer or less flexible than the guide tracks, for example steel or metal guide track retainers and ultra-high molecular weight (“UHWM”) polymer guide tracks, the portion of the guide tracks to which the guide track retainers are mounted may be stiffer and more difficult for the thickened body and door panel to disengage from. Where tracks holders are utilized, the guide track retainers may extend a uniform distance across the guide tracks from top to bottom, or may alternatively extend a different amount across upper portion 160 of the guide tracks than across lower portion 162 of the guide tracks. For example, guide track retainers may only extend a small distance across upper portion 160 to merely help maintain the position of the guide tracks while providing minimal resistance, and across a larger distance across lower 162 in order to add stiffness to the tracks and help increase wind load resistance in the guide tracks at lower portion 162. The guide track retainers may extend across an outer portion of guide tracks 120a, 120b a distance equal to at least depth JJ of guide channel 174 in lower portion 162 of the guide tracks.

This wind load resistance may be further enhanced by filling at least a portion the area between outer edges 178 of the guide tracks and engagement portion 170b in lower portion 162 of the guide tracks with body or insert 180 which maintains the narrowed gap from the engagement portion of the guide track to the doorway opening as seen in FIG. 19B. Alternatively, as seen in FIG. 18B, this area in any embodiment may be left clear in order to better allow the thickened bodies and door panel to escape the guide track if the door panel is impacted by a force.

The positioning of engagement portion 170b closer to rear portion 172 in lower portion 162 of guide tracks 120, 122 may be accomplished by directly molding the lower section of the guide track with a deeper or more inwardly positioned engagement portion, or by providing an insert or inserts for each guide track which fit within the track and provide a new engagement portion at lower portion 162. Tracks which are directly molded may be any of machined or milled UHMW polymers as seen in FIG. 18B, molded UHWM polymers, or though the use of separate insert 180 fixed within the guide tracks as seen in FIG. 19B.

The advantages of using inserts discussed above with respect to the first embodiment of the invention would likewise apply to the present embodiment of the invention. Inserts may likewise be fixed within guide tracks 120, 122 in the same manner as they would be fixed into guide tracks 20, 22, with only one engagement portion being provided within each guide track rather than two engagement portions as utilized in the first embodiment.

In order to ensure a smooth transition between upper portion 160 and lower portion 162 of guide tracks 120, 122, and in order to eliminate any edges which may cause the door panel and any thickened bodies to become stuck as the door panel moves between guide channels 168, 174, as seen in FIGS. 16 and 17, a transition portion 184 of the guide track having a transition channel 185 may be provided between the upper and lower portions of the guide tracks. When a narrower portion guide channel is used at the bottom of the guide tracks, the depth of the transition guide channel should begin at approximately depth FF at the lower portion of the upper guide channel 168, and gradually narrow down to the narrower depth JJ proximate the upper most portion of lower guide channel 174. Engagement portion 170c of transition portion 184 may gradually push the thickened bodies outward from doorway 124, towards rear portion 172 of the guide tracks, gradually removing the slack and tightening the door panel before finally stopping at depth JJ and passing the thickened body off to engagement portion 170b in lower portion 162 of the guide tracks.

While in the foregoing there has been set forth preferred embodiments of the invention, it is to be understood that the present invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying claims.

What is claimed is:

1. A door assembly comprising:
a door panel having a top edge, a bottom edge, a first vertical edge and a second vertical edge,
the door panel being fixed proximate the top edge to a drum, the door panel winding onto and unwinding from the drum to open and close a doorway;
a first side column and a second side column, wherein the first side column is positioned proximate a first side of the doorway and the second side column is positioned proximate a second side of the doorway, the first side column and the second side column each comprising a guide track and each guide track comprising a first portion and a second portion,
the first portion of each guide track defining a first guide channel having a first depth extending from a rear portion of each guide track to a first engagement portion of each guide track, the first engagement portion of each guide track further defining a first gap so that the door panel may extend from the doorway through the first gap into the first guide channel, and
the second portion of each guide track defining a second guide channel having a second depth extending from the rear portion of the guide track to a second engagement portion of each guide track, the second engagement portion of each guide track further defining a second gap so that the door panel may extend from the doorway through the second gap into the second guide channel,
wherein the second depth is less than the first depth.

2. The door assembly of claim 1, wherein the first gap has a first width and the second gap has a second width, the second width being less than the first width.

3. The door assembly of claim 1, wherein each guide track further comprises a transition portion located between the first portion and the second portion, the transition portion defining a transition gap and a transition guide channel which has a transition guide channel depth which decreases from a top portion of the transition guide channel to a bottom portion of the transition guide channel.

4. The door assembly of claim 3, wherein the transition guide channel depth is the first depth at the top portion of the transition guide channel and is the second depth at the bottom portion of the transition guide channel.

5. The door assembly of claim 3, wherein the first gap has a first gap width, the second gap has a second gap width, and the transition gap has a transition gap width, wherein the second gap width is less than the first gap width.

6. The door assembly of claim 5, wherein the transition gap width is equal to the second gap width.

7. The door assembly of claim 5, wherein the transition gap width is equal to the first gap width at a top portion of the transition portion, and the transition gap width is equal to the second gap width at a bottom portion of the transition portion.

8. The door assembly of claim 1, wherein the second portion of each guide track is molded so that the second engagement portion is moved inwards into the guide track so that the second engagement is closer to the rear portion of the guide track than the first engagement portion.

9. The door assembly of claim 8, wherein the second portion of each guide track includes a body, the body extending between the second engagement portion and an outer edge of each guide track bounding the doorway, the body further defining a body gap from the second engagement portion to the outer edge of each guide track so that the door panel may extend through from the doorway through the body gap and the second gap into the second guide channel.

10. The door assembly of claim 1, further comprising at least two inserts, wherein one insert from the at least two inserts is inserted into each guide track to form the second portion of each guide track, each insert having a second engagement portion positioned closer to the rear portion of the guide track the first engagement portion.

11. The door assembly of claim 10, wherein each insert includes a body which fills the guide channel between the first engagement portion to the second engagement portion, the body further defining an insert gap so that the door panel may extend through from the doorway through the insert gap and the second gap into the second guide channel.

12. The door assembly of claim 1 wherein each side column further comprises a guide track retainer mounted to each guide track, each guide track retainer being made from a different material than each guide track, wherein the material of each guide track is more flexible than the material of each guide track retainer.

13. The door assembly of claim 12 wherein each guide track retainer extends a first distance across the first potion of an associated guide track and a second distance across the second portion of the associated guide track, wherein the first distance is different than the second distance.

14. The door assembly of claim 12 wherein each guide track retainer extends across the second portion of an associated guide track a distance that is at least equal to the second depth.

15. The door assembly of claim 1, wherein the first portion of each guide track has a first flexibility and the second portion of each guide track has a second flexibility, wherein the first flexibility is more flexible than the second flexibility.

16. The door assembly of claim 1, wherein the first engagement portion has a different flexibility than the second engagement portion.
